(19) United States
(12) Patent Application Publication
(10) Pub. No.: US 2011/0228570 A1
(43) Pub. Date: Sep. 22, 2011

(54) SWITCHING MODE POWER SUPPLIES WITH PRIMARY SIDE CONTROL AND ASSOCIATED METHODS OF CONTROL

(76) Inventors: En Li, Hangzhou (CN); Junming Zhang, Hangzhou (CN); Yuancheng Ren, Hangzhou (CN)

(21) Appl. No.: 13/048,660

(22) Filed: Mar. 15, 2011

(30) Foreign Application Priority Data
Mar. 16, 2010 (CN) 201010124806.3

(51) Int. Cl. H02M 3/335

(52) U.S. Cl. 363/21.13

(57) ABSTRACT

Switching mode power supplies with primary side control and associated methods of control are disclosed. In one embodiment, a signal with input voltage information and a signal with both input voltage information and output voltage information are provided to a subtracter to generate a feedback signal that is indicative of the output voltage. The feedback signal is then used to control the switching mode power supply.

### CROSS-REFERENCE TO RELATED APPLICATION(S)

This application claims priority to and the benefit of Chinese Patent Application No. 201010124806.3, filed Mar. 16, 2010, the disclosure of which is incorporated herein by reference in its entirety.

### TECHNICAL FIELD

The present technology relates generally to switching mode power supplies.

### BACKGROUND

Switching mode power supplies can be used in adapters and chargers. Typically, a switching mode power supply comprises a primary circuit and a secondary circuit that are isolated by a transformer. As shown in FIG. 1A, the operation of the switching mode power supply used in adapters and chargers is divided into two periods: the first one is a constant current control period (see section B), and the second one is a constant voltage control period (see section A). In section B, at the beginning of a typical full-charge cycle, a constant output current 6 is applied when the output voltage is low or rising to the threshold voltage Vₜₕ. In section A, the output voltage reaches the threshold voltage Vₜₕ, and the switching mode power supply switches to the constant voltage mode and continues until the charging current declines to nearly zero.

In order to keep the output current constant, a secondary current sensing circuitry provides a feedback signal to a control circuit by an opto-coupler. However, such a structure is complicated. In addition, it suffers from unwanted energy losses and low efficiencies. In order to eliminate the opto-coupler and the secondary current sensing circuitry, primary side control is widely used. FIG. 1B shows a conventional primary control circuitry. However, the switching mode power supply in FIG. 1B needs an auxiliary winding for feedback, which increases the cost. Accordingly, a primary side control circuit without an auxiliary winding would be desirable.

### BRIEF DESCRIPTION OF THE DRAWINGS

FIG. 1A schematically shows operation of a switching mode power supply in adapters and chargers.

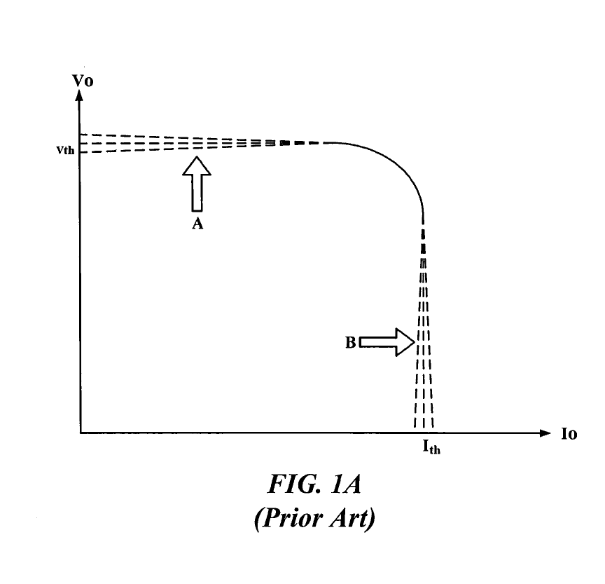

FIG. 1B schematically shows a prior art primary side control switching mode power supply.

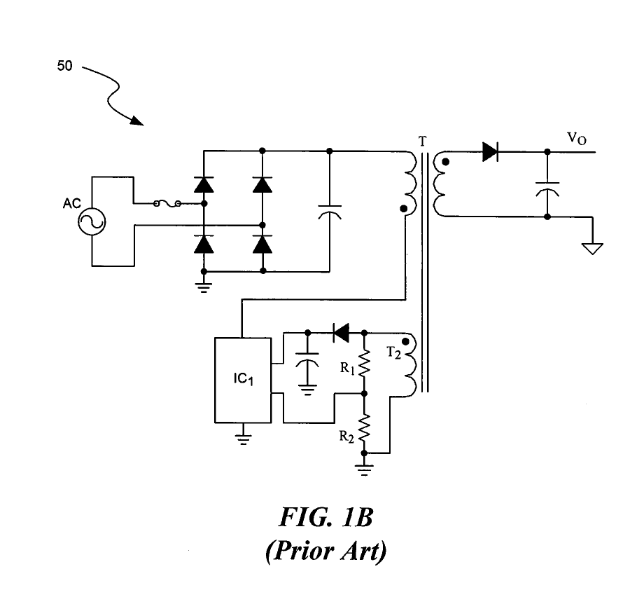

FIG. 2 schematically shows a switching mode power supply with primary side control in accordance with one embodiment of the present technology.

FIG. 3 schematically shows a switching mode power supply with primary side control in accordance with one embodiment of the present technology.

FIG. 4A schematically shows a circuit for the integrated control circuit IC₁ of the switching mode power supply of FIG. 3 in accordance with one embodiment of the present technology.

FIG. 4B shows a schematic circuit for the integrated control circuit IC₁ in accordance with one embodiment of the present technology.

FIG. 4C shows a schematic circuit for the integrated control circuit IC₁ in accordance with one embodiment of the present technology.

FIG. 4D shows a schematic circuit for the integrated control circuit IC₁ in accordance with one embodiment of the present technology.

FIG. 4E shows a schematic circuit for the integrated control circuit IC₁ in accordance with one embodiment of the present technology.

FIG. 4F shows a schematic circuit for the integrated control circuit IC₁ in accordance with one embodiment of the present technology.

FIG. 4G shows a schematic circuit for the integrated control circuit IC₁ in accordance with one embodiment of the present technology.

FIG. 4H shows a schematic circuit for the integrated control circuit IC₁ in accordance with one embodiment of the present technology.

FIG. 5 shows a schematic flowchart of controlling a switching mode power supply in accordance with one embodiment of the present technology.

FIG. 6 shows a schematic flowchart of controlling a switching mode power supply in accordance with one embodiment of the present technology.

### DETAILED DESCRIPTION

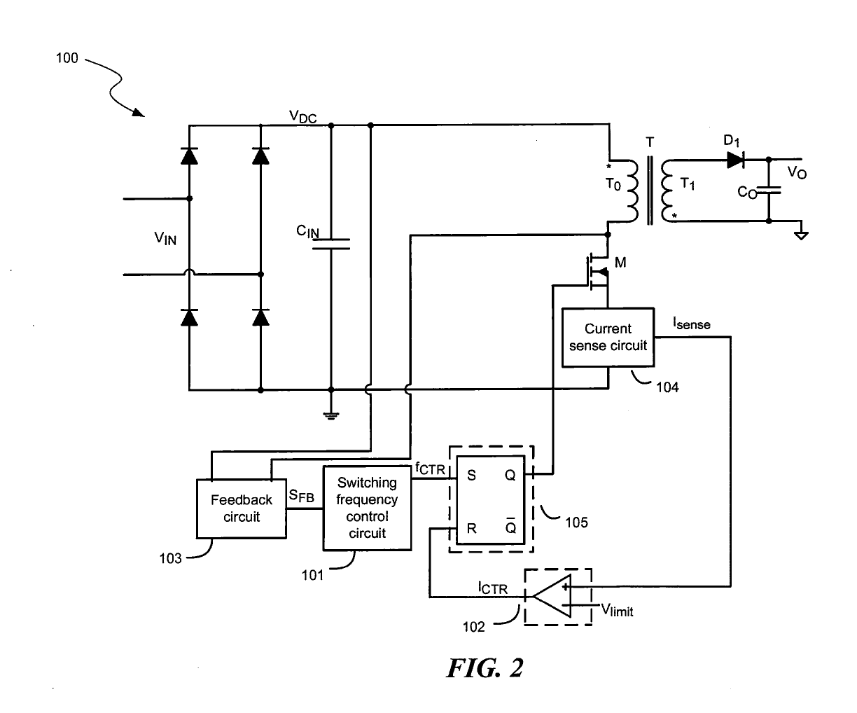

Various embodiments of switching mode power supplies and methods of control are described below. Many of the details, dimensions, angles, shapes, and other features shown in the figures are merely illustrative of particular embodiments of the technology. A person skilled in the relevant art will also understand that the technology may have additional embodiments, and that the technology may be practiced without several of the details of the embodiments described below with reference to FIGS. 2-6.

In one embodiment, a switching mode power supply includes a transformer having a primary winding and a secondary winding. The primary winding has a first terminal and a second terminal. The first terminal is configured to receive an input voltage, and the secondary winding is configured to supply power to a load. A main switch is coupled to the second terminal of the primary winding to control a current flowing through the primary winding. A feedback circuit is coupled to the primary winding to receive a voltage across the primary winding, and based on the voltage across the primary winding, the feedback circuit generates a feedback signal. The switching mode power supply also includes a control circuit having a first input terminal, a second input terminal, a third input terminal, and an output terminal. The first input terminal is coupled to the feedback circuit to receive the feedback signal. The second input terminal is coupled to the main switch to receive the current flowing through the primary winding. The third input terminal is coupled to a peak current reference signal, and based on the feedback signal, the current flowing through the primary winding and the peak current reference signal, the control circuit generates a switching signal to toggle the main switch.

In another embodiment, a method used in a switching mode power supply includes coupling an input voltage to a first terminal of a primary winding of a transformer; coupling a main switch to a second terminal of the primary winding to control a current flowing through the primary winding, and to control an output voltage provided to a load at a secondary winding of the transformer; sensing a voltage across the primary winding to generate a feedback signal indicative of the output voltage; and generating a switching signal in response to (1) the current flowing through the primary winding, (2) the feedback signal, and (3) a current reference signal; wherein the main switch is controlled by the switching signal.

Furthermore, in another embodiment, a method of controlling a switching mode power supply includes coupling an input voltage to a first terminal of a primary winding of a transformer; coupling a main switch to a second terminal of the primary winding to store energy when the main switch is turned on, and to transfer the energy stored in the primary winding to a secondary winding of the transformer when the main switch is turned off; sensing a current flowing through the primary winding to generate a current sensed signal; sensing a voltage across the primary winding to generate a feedback signal indicative of an output voltage of the switching mode power supply; and generating a switching signal in response to (1) the current sensed signal, (2) the feedback signal, and (3) a current reference signal; wherein the main switch is controlled by the switching signal.

FIG. 2 schematically shows a switching mode power supply 100 with primary side control in accordance with one embodiment of the present technology. As shown in FIG. 2, the switching mode power supply 100 comprises a rectifier bridge with a capacitor C₁ₙ coupled across it; a transformer T having a primary winding T₀ and a secondary winding T₁. The primary winding T₀ has a first terminal and a second terminal. The first terminal is configured to receive an input DC voltage V_{DC}, and the secondary winding T₁ is configured to supply power to a load. The power supply 100 also includes a main switch M coupled to the second terminal of the primary winding T₀ to control the current flowing through the primary winding T₀; a diode D₁; an output capacitor Cₒ; a feedback circuit 103 coupled to the primary winding T₀ to receive a voltage across the primary winding, and based on the voltage across the primary winding, the feedback circuit 103 generates a feedback signal; a current sense circuit 104 coupled to the main switch, and the current sense circuit 104 is configured to generate a current sensed signal by sensing the current flowing through the primary winding when the main switch is turned on; and a control circuit having a first input terminal, a second input terminal, a third input terminal, and an output terminal. The first input terminal is coupled to the feedback circuit 103 to receive the feedback signal S_{FB}, the second input terminal is coupled to the main switch M to receive the current flowing through the primary winding T₀, and the third input terminal is coupled to a peak current reference signal Vₗᵢₘᵢₜ. Based on the feedback signal S_{FB}, the current flowing through the primary winding, and the peak current reference signal the control circuit generates a switching signal to toggle the main switch M. The current sense circuit 104 may comprise a resistance sampling circuit, a transformer sampling circuit, or a current amplifier sampling circuit and/or other suitable circuits.

In one embodiment of the present technology, the control circuit comprises a switching frequency control circuit 101 coupled to the feedback circuit 103 to receive the feedback signal. Based on the feedback signal, the switching frequency control circuit 101 generates a switching frequency control signal. The control circuit also comprises a current control circuit 102 configured to receive the current flowing through the primary winding and the peak current reference signal. Based on the current flowing through the primary winding and the peak current reference signal, the current control circuit 102 generates a peak current control signal. the control circuit further comprises a logic circuit 105 coupled to the switching frequency control circuit and the current control circuit. The logic circuit is configured to receive the switching frequency control signal and the peak current control signal, and based on the switching frequency control signal and the peak current control signal, the logic circuit 105 provides the switching signal to toggle the main switch.

The specific embodiment of the switching mode power supply 100 in FIG. 2 is shown as a part of an AC-DC converter. As shown in FIG. 2, a rectifier bridge converts the AC input voltage V_{IN} to the input DC voltage V_{DC}; a transformer T, the main switch M, the diode D₁, and the output capacitor Cₒ are coupled together to form a typical flyback converter. However, in other embodiments, the input voltage can be a DC voltage. In addition, the diode D₁ may be replaced by a synchronous rectifier, and the main switch M may comprise metal oxide semiconductor field effective transistor (MOSFET) or isolated gate bipolar transistor (IGBT), and/or other suitable types of switching devices. The voltage across the capacitor Cₒ is the output voltage Vₒ of the switching mode power supply 100.

In the embodiment of the switching mode power supply 100 in FIG. 2, the switching mode power supply does not include an auxiliary winding, and the first input terminal of the feedback circuit 103 is coupled to the first terminal of the primary winding T₀ to get the information of the input DC voltage V_{DC}. The second input terminal of the feedback circuit 103 is coupled to the second terminal of the transformer T or primary winding T₀ to get the information of the input DC voltage V_{DC} and the output voltage Vₒ. The feedback signal S_{FB} is generated based on the signals in the two input terminals of the feedback circuit 103. According to the switching frequency control signal f_{CTR} and the peak current limit signal I_{CTR}, the logic circuit 105 controls the main switch M to regulate the output voltage Vₒ of the switching mode power supply 100.

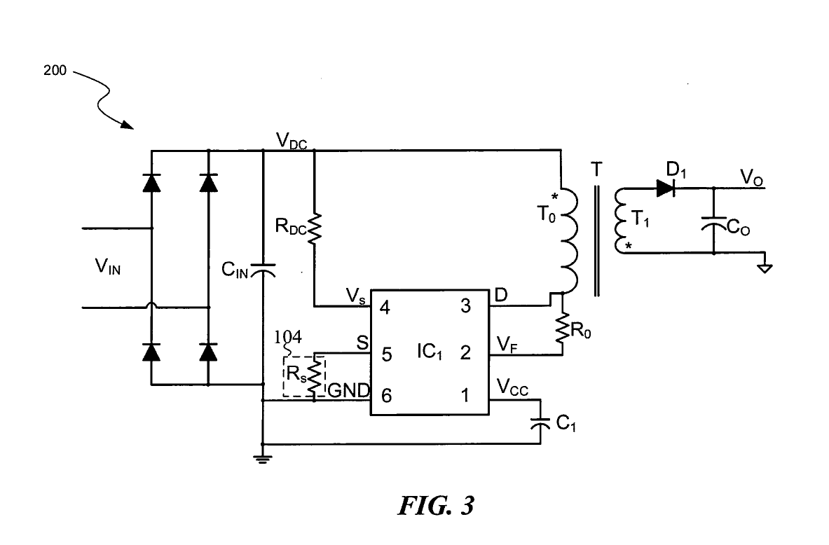

FIG. 3 shows a schematic circuit of a switching mode power supply 200 with primary side control in accordance with one embodiment of the present technology. The operation of the rectifier bridge and the flyback converter have been previously discussed with reference to FIG. 2, and is omitted here for clarity. In the illustrated embodiment of FIG. 3, the switching mode power supply 200 includes an integrated control circuit IC₁, which replaces the main switch M and certain control circuits in switching mode power supply 100; an input resistor R_{DC} having a first terminal and a second terminal, and the first terminal is coupled to the first terminal of the primary winding T₀ to sense the voltage at the first terminal of the primary winding and the second terminal is coupled to the fourth pin (the input pin) Vₛ of the integrated control circuit IC₁; a feedback resistor R₀ having a first terminal and a second terminal, and the first terminal is coupled to the second terminal of the primary winding to sense the voltage at the second terminal of the primary winding and the second terminal is coupled to a second pin V_{F} of the integrated control circuit IC₁; a capacitor C₁ having a first terminal coupled to the first pin V_{CC} of the integrated control circuit IC₁ and a second terminal connected to a primary reference ground. The current sense circuit 104 comprises a sample resistor Rₛ. As can be seen from the description below, the sample resistor Rₛ is coupled in series with the main switch M, which is integrated in the integrated control circuit IC₁. The sample resistor Rₛ may be replaced by a conductance resistor of the main switch M in other embodiments.

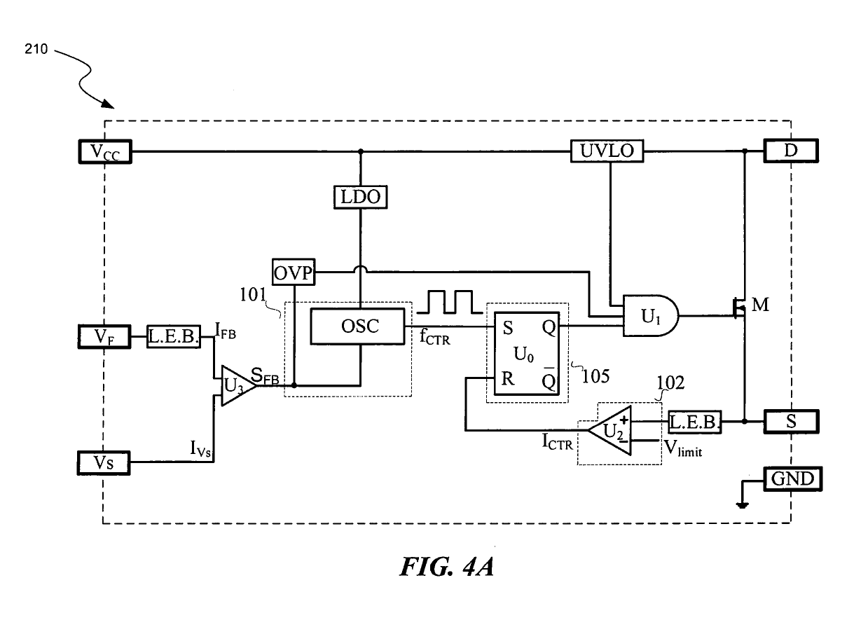

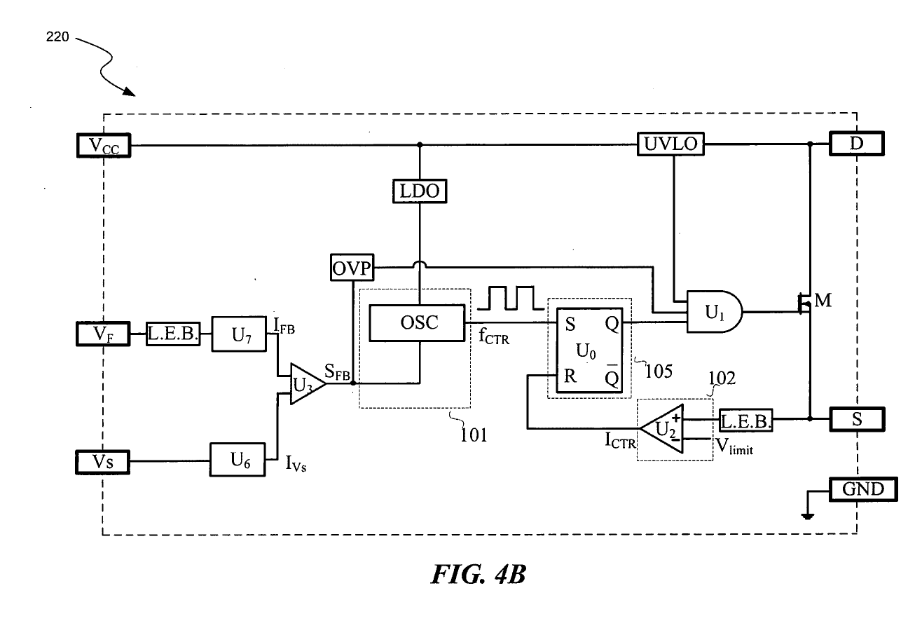

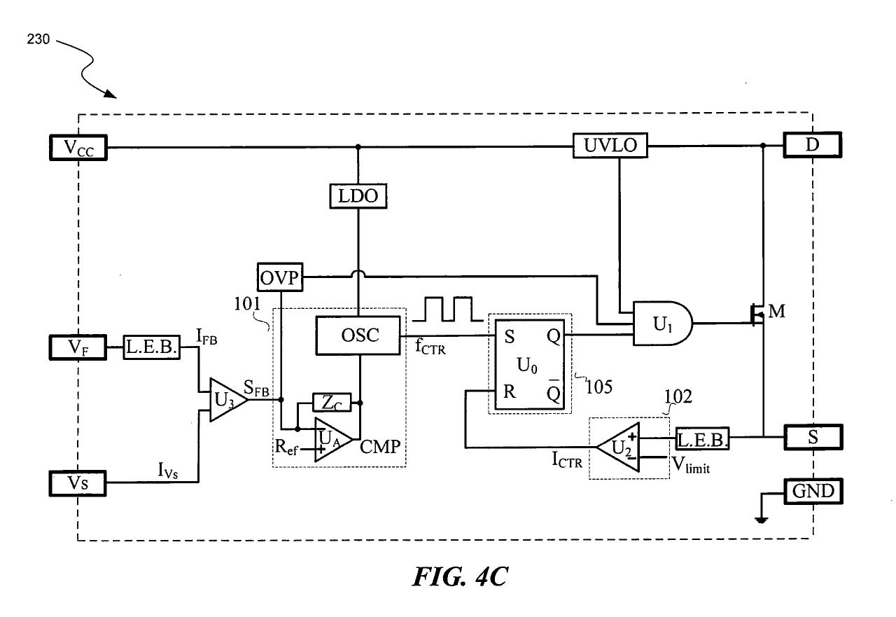

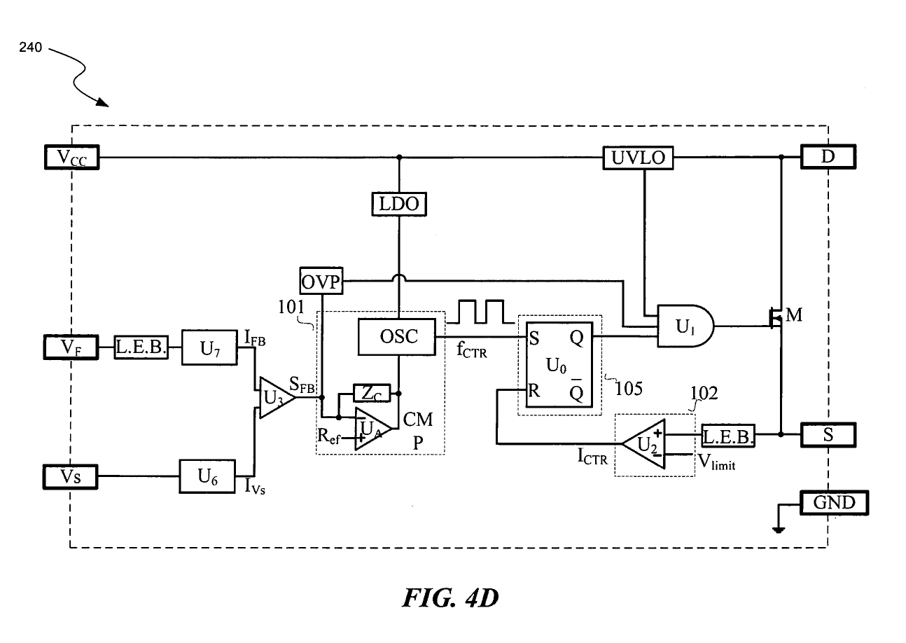

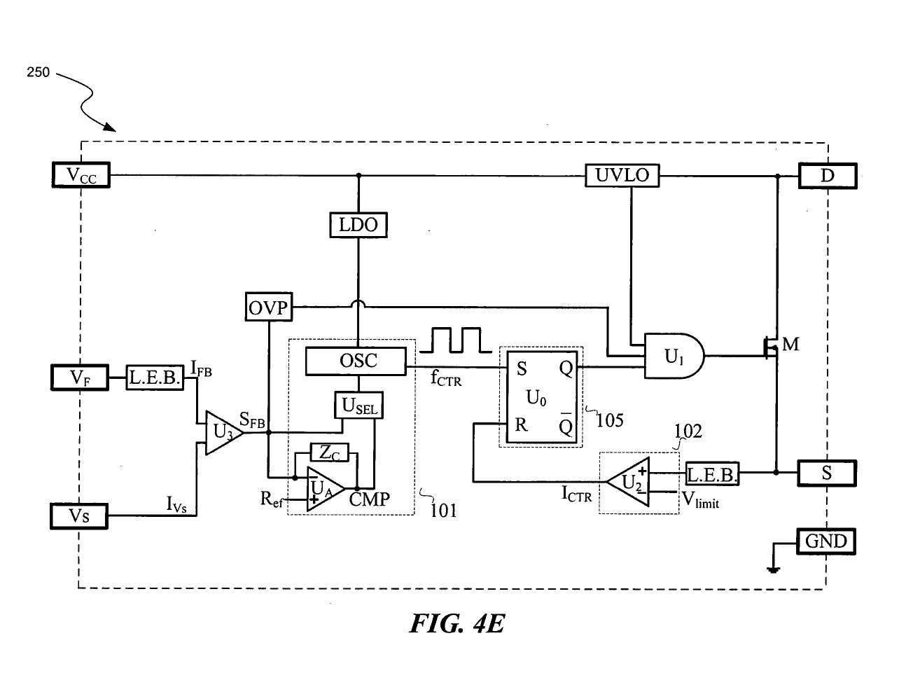

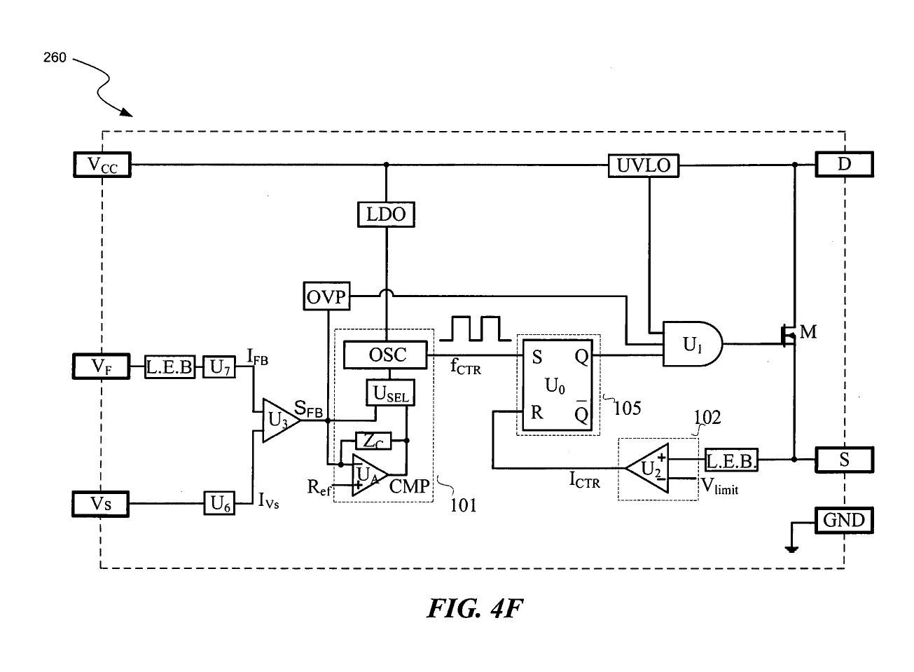

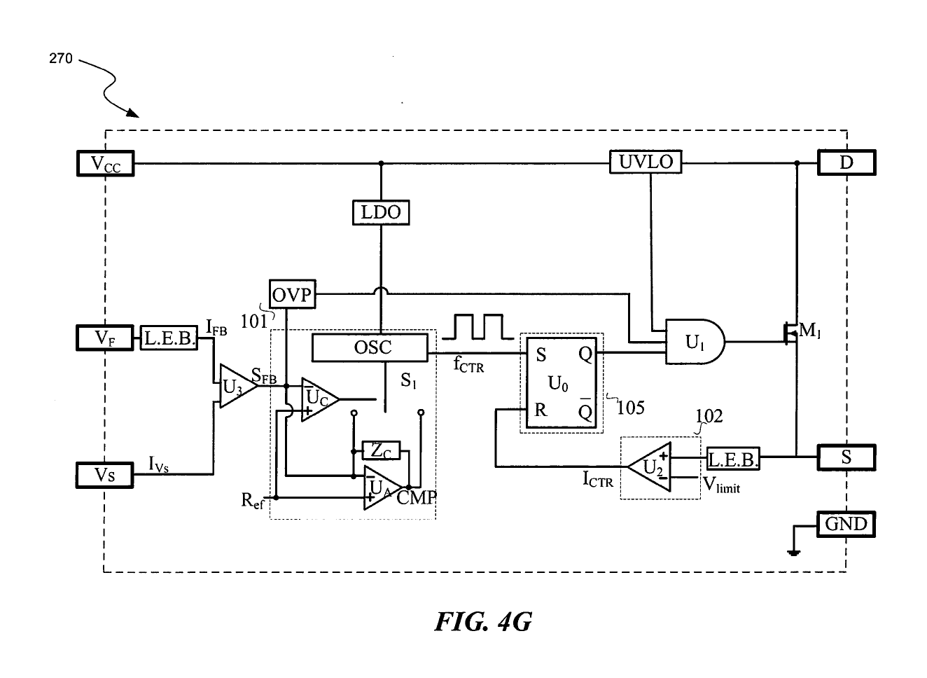

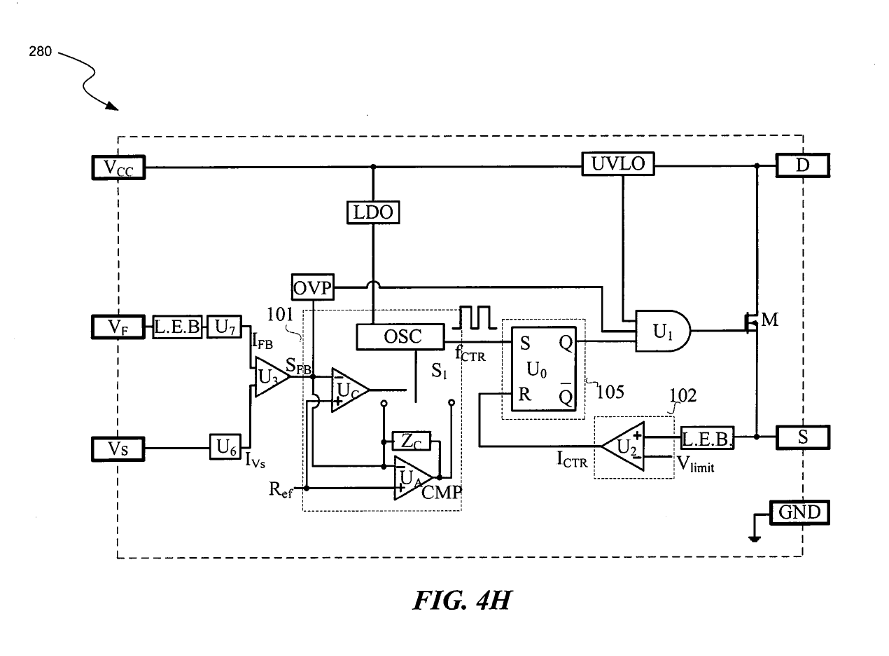

FIG. 4A schematically shows a circuit 210 for the integrated control circuit IC₁ of the switching mode power supply 200 of FIG. 3 in accordance with one embodiment of the present technology. Referring back to FIG. 3, the feedback circuit 103 comprises an input resistor R_{DC} having a first terminal and a second terminal, and the first terminal is coupled to the first terminal of the primary winding T₀ to sense the voltage at the first terminal of the primary winding; a feedback resistor R₀ having a first terminal and a second terminal, and the first terminal is coupled to the second terminal of the primary winding T₀ to sense the voltage at the second terminal of the primary winding T₀; and a subtracter U₃ having a first input terminal, a second input terminal and an output terminal. The first input terminal is coupled to the second terminal of the input resistor R₀ to receive the voltage at the first terminal of the primary winding T₀, The second input terminal is coupled to the second terminal of the feedback resistor R₀ to receive the voltage at the second terminal of the primary winding T₀, and based on the voltage across the primary winding T₀, the subtracter U₃ provides the feedback signal S_{FB} at its output terminal.

Referring back to FIG. 4A, the subtracter U₃ subtracts the signal at the first input terminal and the second input terminal, and the output signal of the subtracter U₃ is indicative of the output signal, i.e., the output signal of the subtracter U₃ is the feedback signal. In this embodiment, the switching frequency control circuit comprises an oscillator OSC that is coupled to the feedback circuit to receive the feedback signal S_{FB}, and based on the feedback signal S_{FB}, the oscillator generates a switching frequency control signal f_{CTR}. The current control circuit 102 comprises a comparator U₂. The integrated control circuit 210 of FIG. 4A also comprises a LDO block that supplies power V_{CC} to the components in the integrated control circuit, a UVLO block for under voltage lockout, and an OVP block for over voltage protection.

In one embodiment of the present technology, the circuit 210 includes two L.E.B. (Lead Edge Blanking) circuits. One L.E.B. circuit is coupled between the V_{F} pin of the integrated control circuit IC₁ and the second input terminal of the subtracter U₃. The other L.E.B circuit is coupled between the S pin of the integrated control circuit IC₁ and the inverting input terminal of comparator U₂. Both of the L.E.B circuits are used to eliminate or at least reduce inaccurate signals caused by the reverse-recovery process of the diode in the secondary side and/or by parasitic signal oscillations.

In one embodiment of the present technology, the logic circuit 105 is a RS flip-flop U₀. The RS flip-flop U₀ has a set terminal S, a reset terminal R, and an output terminal Q. When the switching mode power supply 200 is in normal operation, at the beginning of each cycle, the oscillator outputs a high-level signal to the set terminal S of the RS flip-flop U₀, resulting in a high-level signal in the output terminal Q of the RS flip-flop U₀.

During normal operation, the output of the logic AND gate is determined by the output of the logic circuit. When the main switch M is turned on, the primary winding T₀ starts to store energy. As the current flowing through the main switch M increases, the voltage across the sample resistor Rₛ rises. When the voltage across the sample resistor Rₛ reaches the peak current reference signal Vₗᵢₘᵢₜ, the output of the peak current comparator U₂ goes high, the RS flip-flop U₀ is reset, and the main switch M is turned off. Then the energy stored in the primary winding T₀ is transferred to the secondary winding T₁. When the main switch M is turned off, the voltage across the feedback resistor R₀ is V_{DC}+nxVₒ, and the signal at the first input terminal of the subtracter U₃ is:

$${I}_{FB} = \frac{{V}_{DC} + n \times {V}_{O}}{{R}_{0}}$$

where n is the turn ratio of the primary winding T₀ to the secondary winding T₁; while the voltage across the input resistor R_{DC} is V_{DC}, and the signal at the second input terminal of the subtracter U₃ is:

$${I}_{VS} = \frac{{V}_{DC}}{{R}_{DC}} .$$

The feedback signal S_{FB} in the output terminal of the subtracter U₃ is generated based on I_{FB} and I_{VS}. If R₀=R_{DC}, the output of subtracter U₃ is:

$$\begin{matrix}{S}_{FB} = {I}_{FB} - {I}_{VS} \\ = \frac{{V}_{DC} + n \times {V}_{O}}{{R}_{0}} - \frac{{V}_{DC}}{{R}_{DC}} \\ = \frac{n \times {V}_{O}}{R}\end{matrix} \qquad ( 1 )$$

As can be seen from the above equation (1), the feedback signal S_{FB} is proportional to the output voltage Vₒ of the switching mode power supply 200.

If R₀ is not equal to R_{DC}, impedance matching circuits U₆ and U₇ may be inserted into the circuit before the subtracter U₃. FIG. 4B shows a schematic circuit 220 for the integrated control circuit IC₁ in accordance with one embodiment of the present technology. Compared to the example of FIG. 4A, the impedance matching circuits U₆ and U₇ are added in circuit 220. The first impedance matching circuit U₆ has an input terminal and an output terminal. The input terminal is coupled to the second terminal of the input resistor R_{DC} to match the impedance of the input resistor, and the output terminal delivers the voltage to the first terminal of the primary winding T₀. The second impedance matching circuit U₇ has an input terminal and an output terminal. The input terminal is coupled to the second terminal of the feedback resistor R₀ to match the impedance of the feedback resistor, and the output terminal delivers the voltage at the second terminal of the primary winding T₀.

Suppose U₆ has a coefficient k1 and U₇ has a coefficient k2, then:

$${I}_{VS} = \frac{k 1 \times {V}_{DC}}{{R}_{DC}} , \\ {I}_{FB} = \frac{k 2 ( {V}_{DC} + n \times {V}_{O} )}{{R}_{0}}$$

if the coefficients k1 and k2 are selected so that k2/R0=k1/R_{DC}, then:

$$\begin{matrix}{S}_{FB} = {I}_{FB} - {I}_{VS} \\ = \frac{k 2 ( {V}_{DC} + n \times {V}_{O} )}{{R}_{0}} - \frac{k 1 \times {V}_{DC}}{{R}_{DC}} \\ = \frac{k 2 \times n \times {V}_{O}}{{R}_{0}}\end{matrix} \qquad ( 2 )$$

It can be seen in equation (2) that the feedback signal S_{FB} in circuit 220 is in proportion to Vₒ.

As mentioned hereinbefore, the switching mode power supply 200 operates under the constant current mode before the output voltage Vₒ reaches the threshold voltage Vₜₕ. Constant current control with primary side control will be explained with reference to FIGS. 4A and 4B.

According to the law of energy conservation, the energy of the primary winding T₀ and the energy of the secondary winding T₁ are equal. When the switching mode power supply 200 works under discontinuous conduction mode, the law of energy conservation for the switching mode power supply 200 is as follows:

$$\frac{1}{2} L \times {i}_{peak}^{2} \times {F}_{S} \times η = {V}_{O} \times {I}_{O}$$

And when the switching mode power supply 200 operates under continuous conduction mode, the law of conservation of energy for the switching mode power supply 200 is illustrated as:

$$\frac{1}{2} L \times ( {i}_{peak}^{2} - {i}_{initial}^{2} ) \times {F}_{S} \times η = {V}_{O} \times {I}_{O}$$

wherein Fₛ is the switching frequency of the switching mode power supply 200, η is the conversion efficiency of the switching mode power supply 200, L is the inductance of the primary winding T₀, iₚₑₐₖ is the peak current value of the current flowing through the main switch M, and iᵢₙᵢₜᵢₐₗ is the initial current value of the current flowing through main switch M when the main switch M is turned on. All of them are given in a particular system. So if Fₛ and Vₒ are varied in the same proportion, the output current Iₒ is generally constant. As previously discussed, the feedback signal S_{FB} is varied with the output voltage Vₒ, and the switching frequency control signal f_{CTR} is varied with the feedback signal S_{FB}, so if the switching frequency control signal f_{CTR} and the output voltage Vₒ are varied in the same proportion, a constant output current Iₒ can be obtained.

The switching mode power supply 200 operates under the constant voltage mode when the output voltage reaches the threshold voltage Vₜₕ. FIG. 4C and FIG. 4D illustrate schematic circuits 230 and 240 that realize constant voltage control with primary side feedback in accordance with one embodiment of present technology. Compared to the circuit 210, the circuit 230 in FIG. 4C further comprises an error amplifier U_{A} having a first input terminal, a second input terminal, and an output terminal. The first input terminal is coupled to the feedback circuit 103 to receive the feedback signal S_{FB}, and the second input terminal is coupled to a reference signal R_{ef} on FIG. 4C. Based on the feedback signal S_{FB} and the reference signal R_{ef}, the error amplifier U_{A} outputs an amplified error signal at the output terminal. A compensating circuit Z_{c} is coupled between the first input terminal and the output terminal of the error amplifier U_{A}. An oscillator is coupled to the output terminal of the error amplifier U_{A} to receive the amplified error signal CMP, and based on the amplified error signal CMP, the oscillator provides the switching frequency control signal f_{CTR}.

During operation, the error amplifier U_{A} clamps the feedback signal S_{FB} to the reference signal R_{ef}, which is indicative of the threshold voltage Vₜₕ, i.e., S_{FB}=R_{ef}, so the output voltage Vₒ of the circuit 200 can be maintained at Vₜₕ. When a sudden increase in the output voltage occurs, the feedback signal S_{FB} increases. Then the output signal CMP of the error amplifier U_{A} decreases, and the frequency F_{S} controlled by the switching frequency control signal f_{CTR} decreases accordingly.

According to the law of conservation of energy:

$$\frac{1}{2} L \times {i}_{peak}^{2} \times {F}_{S} \times η = {V}_{O} \times {I}_{O} ( under discontinuous curent mode ) , \\ or$$

$$\frac{1}{2} L ( {i}_{peak}^{2} - {i}_{initial}^{2} ) \times {F}_{S} \times η = {V}_{O} \times {I}_{O} ( under discontinuous curent mode ) ,$$

the output voltage Vₒ decreases accordingly (Iₒ is nearly zero and could be seen as a constant). Thus, a negative feedback loop is formed. The output voltage Vₒ is then clamped to the threshold voltage Vₜₕ. When the output voltage Vₒ decreases suddenly, the switching mode power supply 200 with the integrated control circuit 230 has a similar response.

FIG. 4D shows a schematic circuit 240 for the integrated control circuit IC₁ in the switching mode power supply 200 in accordance with one embodiment of the present technology. Compared to the circuit 230, two impedance matching circuits U₆ and U₇ are added in FIG. 4D. The function of the impedance matching circuits U₆ and U₇ is similar to that in FIG. 4B. The switching mode power supply 200 with the integrated control circuit 240 realizes constant voltage control generally similarly to that of the integrated control circuit 230 does, which is omitted here for clarity.

FIG. 4E schematically shows a circuit 250 for the integrated control circuit IC₁ of the switching mode power supply 200 in FIG. 3 in accordance with one embodiment of the present technology. In the example of FIG. 4E, the integrated control circuit 250 is a combination of the integrated control circuit 210 and the integrated control circuit 230. Compared to the integrated control circuit 230 of FIG. 4C, a selector U_{SEL} is inserted into the switching frequency control circuit 101 in FIG. 4E. The selector U_{SEL} has a first input terminal, a second input terminal, and an output terminal. The first input terminal is coupled to the feedback circuit 103 to receive the feedback signal S_{FB}, and the second input terminal is coupled to the output terminal of the error amplifier U_{A} to receive the amplified error signal CMP, and based on the feedback signal S_{FB} and the amplified error signal CMP, an output signal is provided at the output terminal of the selector. In one embodiment, the selector U_{SEL} selects the lower value of the feedback signal S_{FB} and the amplified error signal CMP as the output signal. The oscillator is coupled to the output terminal of the selector U_{SEL}, and based on the output signal of the selector U_{SEL}, the oscillator provides the switching frequency control signal f_{CTR}.

Before the output voltage of the switching mode power supply 200 reaches the threshold voltage Vₜₕ, the switching mode power supply 200 operates under the constant current mode, and the feedback signal S_{FB}, which is proportional to the output voltage Vₒ, is smaller than the amplified error signal CMP of the error amplifier U_{A}. Thus, the feedback signal S_{FB} is selected by the selector U_{SEL}. The selector U_{SEL} provides the feedback signal S_{FB} to the oscillator and controls the frequency F_{S} of the switching signal. As such, the integrated control circuit 250 operates as the integrated control circuit 210 does, and the switching mode power supply 200 operates under the constant current mode.

The amplified error signal CMP of the error amplifier U_{A} decreases and the feedback signal S_{FB} increases as the output voltage Vₒ increases. When the output voltage Vₒ of the switching mode power supply 200 reaches its threshold voltage Vₜₕ, the amplified error signal CMP of error amplifier U_{A} becomes smaller than the feedback signal S_{FB}. Thus, the amplified error signal CMP is selected by the selector U_{SEL}. The selector U_{SEL} provides the amplified error signal CMP to the oscillator and controls the frequency F_{S}. As such, the integrated control circuit 250 operates as the integrated control circuit 230, and the switching mode power supply 200 operates under the constant voltage mode.

FIG. 4F shows a schematic circuit 260 for the integrated control IC₁ in the switching mode power supply 200 in according with one embodiment of the present technology. Compared to the integrated control circuit 250, the impedance matching circuits U₆ and U₇ are added in FIG. 4F, the function of which is generally similar to that in FIG. 4B. The switching mode power supply 200 with the integrated control circuit 260 realizes constant current control and constant voltage control generally similarly to the integrated control circuit 250, which is omitted here for clarity.

FIG. 4G shows a schematic circuit 270 for the integrated control circuit IC₁ in the switching mode power supply 200 in accordance with yet another embodiment of the present technology. Compared to the integrated control circuit 250 in FIG. 4E, a selectable circuit S₁ and a comparator U_{c} replace the selector U_{SEL}. The selectable circuit S₁ has a controllable terminal, a selectable terminal, and an output terminal. The controllable terminal is coupled to the comparator U_{C} to receive the comparison signal, and the selectable terminal is controllably coupled to the feedback signal or to the amplified error signal. Based on the comparison signal, the selectable circuit selects the feedback signal or the amplified error signal as an output signal provided by the output terminal.

The comparator U_{C} has a first input terminal and a second input terminal. The first input terminal is coupled to the feedback circuit to receive the feedback signal S_{FB}, and the second input terminal is coupled to a reference signal R_{ef}. Based on the feedback signal S_{FB} and the reference signal R_{ef}, the comparator U_{C} generates a comparison signal. The selectable circuit S₁ may be a SPDT (single-pole double-throw) or a DPDT (double-pole double-throw) and/or other suitable types of selectable circuit. The oscillator is coupled to the output terminal of the selectable circuit, and based on the output signal provided by the output terminal of the selectable circuit, the oscillator provides the switching frequency control signal.

In one embodiment of the present technology, before the output voltage Vₒ of the switching mode power supply 200 reaches the threshold voltage Vₜₕ, the switching mode power supply 200 operates under the constant current mode, and the feedback signal S_{FB} is lower than the reference voltage R_{ef}. Thus, the comparator U_{C} outputs a high-level voltage that causes the selectable circuit S₁ to couple the feedback signal S_{FB} to the oscillator. As such, the integrated control circuit 270 operates as the integrated control circuit 210, and the switching mode power supply 200 operates under the constant current mode.

When the output voltage Vₒ of switching mode power supply 200 reaches its threshold voltage Vₜₕ, the feedback signal S_{FB} is equal to the reference voltage R_{ef}, and the comparator U_{C} outputs a low-level voltage, so the amplified error signal CMP of the error amplifier U_{A} is coupled to the oscillator. As such, the integrated control circuit 270 operates as the integrated control circuit 230 does, and the switching mode power supply 200 operates under the constant voltage mode.

FIG. 4H shows a schematic circuit 280 for the integrated control circuit IC₁ in the switching mode power supply 200 in accordance with one embodiment of the present technology. Compared to the integrated control circuit 270, the impedance matching circuits U₆ and U₇ are added, the function of which is similar to that in FIG. 4B. The switching mode power supply 200 with the integrated control circuit 280 realizes the constant current control and the constant voltage control generally similarly as the integrated control circuit 270.

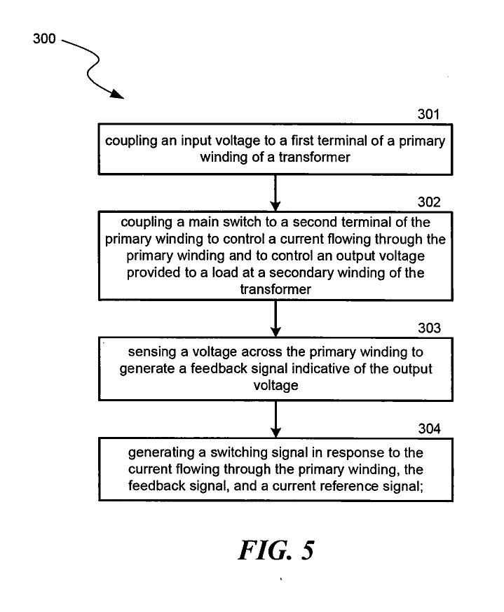

Furthermore, the present technology discloses a method of controlling a switching mode power supply. FIG. 5 shows a schematic flowchart 300 in accordance with one embodiment of the present technology. In the embodiment of FIG. 5, the method comprises stage 301, coupling an input voltage to a first terminal of a primary winding of a transformer; stage 302, coupling a main switch to a second terminal of the primary winding to control the current flowing through the primary winding, and to control an output voltage provided to a load at a secondary winding of the transformer; stage 303, sensing the voltage across the primary winding to generate a feedback signal indicative of the output voltage; and stage 304, generating a switching signal in response to (1) the current flowing through the primary winding, (2) the feedback signal, and (3) a current reference signal; wherein the main switch is controlled by the switching signal.

In one embodiment, stage 303, sensing the voltage across the primary winding comprises coupling an input resistor to the first terminal of the primary winding to sense the voltage at the first terminal of the primary winding; coupling a feedback resistor to the second terminal of the primary winding to sense a voltage at the second terminal of the primary winding; and subtracting the voltage at the second terminal of the primary winding from the voltage at the first terminal of the primary winding.

In one embodiment, stage 304, generating a switching signal comprises generating a switching frequency control signal in response to the feedback signal; generating a peak current control signal in response to the current flowing through the primary winding and the current reference signal; and generating the switching signal in response to the switching frequency control signal and the peak current control signal.

In one embodiment, generating a switching control frequency signal comprises amplifying the difference between the feedback signal and a reference signal to generate an amplified error signal; and generating the switching frequency control signal in response to the amplified error signal. In one embodiment, generating a switching control frequency signal comprises comparing the feedback signal with a reference signal to generate a comparison signal; amplifying the difference between the feedback signal and the reference signal to generate an amplified error signal; coupling the feedback signal or the amplified error signal to an oscillator in response to the comparison signal; and generating the switching frequency control signal from the oscillator.

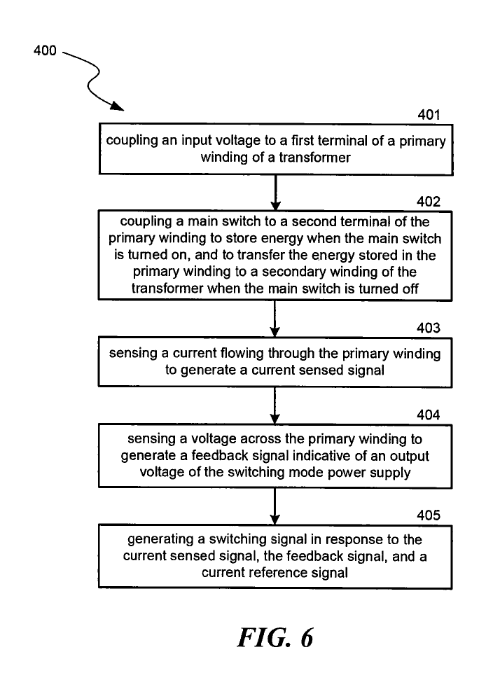

FIG. 6 shows a schematic flowchart 400 of a method of controlling a switching mode power supply in accordance with one embodiment of the present technology. The method comprises stage 401, coupling an input voltage to a first terminal of a primary winding of a transformer; stage 402, coupling a main switch to a second terminal of the primary winding to store energy when the main switch is turned on, and to transfer the energy stored in the primary winding to a secondary winding of the transformer when the main switch is turned off; stage 403, sensing the current flowing through the primary winding to generate a current sensed signal; stage 404, sensing the voltage across the primary winding to generate a feedback signal indicative of an output voltage of the switching mode power supply; and stage 405, generating a switching signal in response to (1) the current sensed signal, (2) the feedback signal, and (3) a current reference signal; wherein the main switch is controlled by the switching signal.

In one embodiment, stage 404, sensing the voltage across the primary winding to generate a feedback signal indicative of an output voltage of the switching mode power supply, comprises coupling an input resistor to the first terminal of the primary winding to sense the voltage at the first terminal of the primary winding; coupling a feedback resistor to the second terminal of the primary winding to sense the voltage at the second terminal of the primary winding; and subtracting the voltage at the second terminal of the primary winding from the voltage at the first terminal of the primary winding.

In one embodiment, stage 405, generating a switching signal, comprises generating a switching frequency control signal in response to the feedback signal; generating a peak current control signal in response to the current sensed signal and the current reference signal; and generating the switching signal in response to the switching frequency control signal and the peak current control signal.

From the foregoing, it will be appreciated that specific embodiments of the technology have been described herein for purposes of illustration, but that various modifications may be made without deviating from the disclosed technology. Elements of one embodiment may be combined with other embodiments in addition to or in lieu of the elements of the other embodiments. Accordingly, the technology is not limited except as by the appended claims.

I/We claim:

1. A switching mode power supply, comprising:
a transformer having a primary winding and a secondary winding, wherein the primary winding has a first terminal configured to receive an input voltage and a second terminal, the secondary winding being configured to supply power to a load;
a main switch coupled to the second terminal of the primary winding to control a current flowing through the primary winding;
a feedback circuit coupled to the primary winding to receive a voltage across the primary winding and generate a feedback signal based on the voltage across the primary winding; and
a control circuit having a first input terminal, a second input terminal, a third input terminal, and an output terminal, wherein:
the first input terminal is coupled to the feedback circuit to receive the feedback signal;
the second input terminal is coupled to the main switch to receive the current flowing through the primary winding;
the third input terminal is coupled to a peak current reference signal; and
based on the feedback signal, the current flowing through the primary winding, and the peak current reference signal, the control circuit is configured to generate a switching signal to toggle the main switch.

2. The switching mode power supply of claim 1, further comprising a current sense circuit coupled to the main switch, wherein the current sense circuit is configured to generate a current sensed signal by sensing the current flowing through the primary winding when the main switch is turned on.

3. The switching mode power supply of claim 1 wherein the control circuit comprises:
a switching frequency control circuit coupled to the feedback circuit to receive the feedback signal, and wherein based on the feedback signal, the switching frequency control circuit generates a switching frequency control signal;
a current control circuit configured to receive the current flowing through the primary winding and the peak current reference signal, and wherein based on the current flowing through the primary winding and the peak current reference signal, the current control circuit generates a peak current control signal; and
a logic circuit coupled to the switching frequency control circuit and the current control circuit, wherein the logic circuit is configured to receive the switching frequency control signal and the peak current control signal, and wherein based on the switching frequency control signal and the peak current control signal, the logic circuit provides the switching signal to toggle the main switch.

4. The switching mode power supply of claim 3, wherein the feedback circuit comprises:
an input resistor having a first terminal and a second terminal, wherein the first terminal is coupled to the first terminal of the primary winding to sense a voltage at the first terminal of the primary winding;
a feedback resistor having a first terminal and a second terminal, wherein the first terminal is coupled to the second terminal of the primary winding to sense a voltage at the second terminal of the primary winding; and
a subtracter having a first input terminal, a second input terminal and an output terminal, wherein the first input terminal is coupled to the second terminal of the input resistor to receive the voltage at the first terminal of the primary winding, the second input terminal is coupled to the second terminal of the feedback resistor to receive the voltage at the second terminal of the primary winding, and wherein based on the voltage across the primary winding, the subtracter provides the feedback signal at its output terminal.

5. The switching mode power supply of claim 3, wherein the feedback circuit comprises:
an input resistor having a first terminal and a second terminal, wherein the first terminal is coupled to the first terminal of the primary winding to sense a voltage at the first terminal of the primary winding;
a feedback resistor having a first terminal and a second terminal, wherein the first terminal is coupled to the second terminal of the primary winding to sense a voltage at the second terminal of the primary winding;
a first impedance matching circuit having an input terminal and an output terminal, wherein the input terminal is coupled to the second terminal of the input resistor to match the impedance of the input resistor, and the output terminal delivers the voltage from the first terminal of the primary winding;
a second impedance matching circuit having an input terminal and an output terminal, wherein the input terminal is coupled to the second terminal of the feedback resistor to match the impedance of the feedback resistor, and the output terminal delivers the voltage from the second terminal of the primary winding; and
a subtracter having a first input terminal, a second input terminal and an output terminal, wherein the first input terminal is coupled to the output terminal of the first impedance matching circuit to receive the voltage from the first terminal of the primary winding, the second input terminal is coupled to the output terminal of the second impedance matching circuit to receive the voltage from the second terminal of the primary winding, and wherein based on the voltage across the primary winding, the subtracter provides the feedback signal at its output terminal.

6. The switching mode power supply of claim 3, wherein the switching frequency control circuit comprises an oscillator coupled to the feedback circuit to receive the feedback signal, and wherein based on the feedback signal, the oscillator generates the switching frequency control signal.

7. The switching mode power supply of claim 4, wherein the switching frequency control circuit comprises:
an error amplifier having a first input terminal, a second input terminal, and an output terminal, wherein the first input terminal is coupled to the feedback circuit to receive the feedback signal, and the second input terminal is coupled to a reference signal, and based on the feedback signal and the reference signal, the error amplifier outputs an amplified error signal at the output terminal;
a compensation circuit coupled between the first input terminal and the output terminal of the error amplifier; and
an oscillator coupled to the output terminal of the error amplifier to receive the amplified error signal, and wherein based on the amplified error signal, the oscillator provides the switching frequency control signal.

8. The switching mode power supply of claim 5, wherein the switching frequency control circuit comprises:
an error amplifier having a first input terminal, a second input terminal, and an output terminal, wherein the first input terminal is coupled to the feedback circuit to receive the feedback signal, and the second input terminal is coupled to a reference signal, and wherein based on the feedback signal and the reference signal, the error amplifier outputs an amplified error signal at the output terminal;
a compensation circuit coupled between the first input terminal and the output terminal of the error amplifier; and
an oscillator coupled to the output terminal of the error amplifier to receive the amplified error signal, and wherein based on the amplified error signal, the oscillator provides the switching frequency control signal.

9. The switching mode power supply of claim 4, wherein the switching frequency control circuit comprises:
an error amplifier having a first input terminal, a second input terminal, and an output terminal, wherein the first input terminal is coupled to the feedback circuit to receive the feedback signal, and the second input terminal is coupled to a reference signal, and wherein based on the feedback signal and the reference signal, the error amplifier outputs an amplified error signal at the output terminal;
a compensation circuit coupled between the first input terminal and the output terminal of the error amplifier;
a selector having a first input terminal, a second input terminal, and an output terminal, wherein the first input terminal is coupled to the feedback circuit to receive the feedback signal, and the second input terminal is coupled to the output terminal of the error amplifier to receive the amplified error signal, and wherein based on the feedback signal and the amplified error signal, an output signal is provided at the output terminal of the selector; and
an oscillator coupled to the output terminal of the selector, and wherein based on the output signal provided by the output terminal of the selector, the oscillator provides the switching frequency control signal.

10. The switching mode power supply of claim 5, wherein the switching frequency control circuit comprises:
an error amplifier having a first input terminal, a second input terminal, and an output terminal, wherein the first input terminal is coupled to the feedback circuit to receive the feedback signal, and the second input terminal is coupled to a reference signal, and wherein based on the feedback signal and the reference signal, the error amplifier outputs an amplified error signal at its output terminal;
a compensation circuit coupled between the first input terminal and the output terminal of the error amplifier;
a selector having a first input terminal, a second input terminal, and an output terminal, wherein the first input terminal is coupled to the feedback circuit to receive the feedback signal, and the second input terminal is coupled to the output terminal of the error amplifier to receive the amplified error signal, and wherein based on the feedback signal and the error amplified signal, an output signal is provided at the output terminal of the selector; and
an oscillator coupled to the output terminal of the selector, and wherein based on the output signal of the selector, the oscillator provides the switching frequency control signal.

11. The switching mode power supply of claim 4, wherein the switching frequency control circuit comprising:
a comparator having a first input terminal and a second input terminal, wherein the first input terminal is coupled to the feedback circuit to receive the feedback signal, and the second input terminal is coupled to a reference signal, and based on the feedback signal and the reference signal, the comparator generates a comparison signal;
an error amplifier having a first input terminal, a second input terminal, and an output terminal, wherein the first input terminal is coupled to the feedback circuit to receive the feedback signal, and the second input terminal is coupled to the reference signal, and wherein based on the feedback signal and the reference signal, the error amplifier outputs an amplified error signal at its output terminal;
a compensation circuit coupled between the first input terminal and the output terminal of the error amplifier;
a selectable circuit having a controllable terminal, a selectable terminal, and an output terminal, wherein the controllable terminal is coupled to the comparator to receive the comparison signal, the selectable terminal is controllably coupled to the feedback signal or the amplified error signal, and wherein based on the comparison signal, the selectable circuit selects the feedback signal or the amplified error signal as an output signal provided by the output terminal; and
an oscillator coupled to the output terminal of the selectable circuit, and wherein based on the output signal provided by the output terminal of the selectable circuit, the oscillator provides the switching frequency control signal.

12. The switching mode power supply of claim 5, wherein the switching frequency control circuit comprising:
a comparator having a first input terminal and a second input terminal, wherein the first input terminal is coupled to the feedback circuit to receive the feedback signal, and the second input terminal is coupled to a reference signal, and wherein based on the feedback signal and the reference signal, the comparator generates a comparison signal;
an error amplifier having a first input terminal, a second input terminal, and an output terminal, wherein the first input terminal is coupled to the feedback circuit to receive the feedback signal, and the second input terminal is coupled to the reference signal, and wherein based on the feedback signal and the reference signal, the error amplifier outputs an amplified error signal at its output terminal;
a compensation circuit coupled between the first input terminal and the output terminal of the error amplifier;
a selectable circuit having a controllable terminal, a selectable terminal, and an output terminal, wherein the controllable terminal is coupled to the comparator to receive the comparison signal, the selectable terminal is controllably coupled to the feedback signal or the amplified error signal, and wherein based on the comparison signal, the selectable circuit selects the feedback signal or the amplified error signal as an output signal provided by the output terminal; and
an oscillator coupled to the output terminal of the selectable circuit, and wherein based on the output signal provided by the output terminal of the selectable circuit, the oscillator provides the switching frequency control signal.

13. A method of controlling a switching mode power supply, comprising:
coupling an input voltage to a first terminal of a primary winding of a transformer;
coupling a main switch to a second terminal of the primary winding to control a current flowing through the primary winding and to control an output voltage provided to a load at a secondary winding of the transformer;
sensing a voltage across the primary winding to generate a feedback signal that is indicative of the output voltage;
generating a switching signal in response to (1) the current flowing through the primary winding, (2) the feedback signal, and (3) a current reference signal; and
controlling the main switch with the switching signal.

14. The method of claim 13, wherein sensing the voltage across the primary winding to generate the feedback signal that is indicative of the output voltage comprises:
coupling an input resistor to the first terminal of the primary winding to sense a voltage at the first terminal of the primary winding;
coupling a feedback resistor to the second terminal of the primary winding to sense a voltage at the second terminal of the primary winding; and
subtracting the voltage from the second terminal of the primary winding from the voltage from the first terminal of the primary winding.

15. The method of claim 13, wherein generating the switching signal comprises:
generating a switching frequency control signal in response to the feedback signal;
generating a peak current control signal in response to the current flowing through the primary winding and the current reference signal; and
generating the switching signal in response to the switching frequency control signal and the peak current control signal.

16. The method of claim 15, wherein generating the switching frequency control signal in response to the feedback signal comprises:
amplifying the difference between the feedback signal and a reference signal to generate an amplified error signal; and
generating the switching frequency control signal in response to the amplified error signal.

17. The method of claim 15, wherein generating the switching control frequency signal in response to the feedback signal comprises:
comparing the feedback signal with a reference signal to generate a comparison signal;
amplifying the difference between the feedback signal and the reference signal to generate an amplified error signal;
coupling the feedback signal or the amplified error signal to an oscillator in response to the comparison signal; and
generating the switching frequency control signal from the oscillator.

18. A method of controlling a switching mode power supply, comprising:
coupling an input voltage to a first terminal of a primary winding of a transformer;
coupling a main switch to a second terminal of the primary winding to store energy when the main switch is turned on, and to transfer the energy stored in the primary winding to a secondary winding of the transformer when the main switch is turned off;
sensing a current flowing through the primary winding to generate a current sensed signal;
sensing a voltage across the primary winding to generate a feedback signal that is indicative of an output voltage of the switching mode power supply;
generating a switching signal in response to (1) the current sensed signal, (2) the feedback signal, and (3) a current reference signal; wherein the main switch is controlled by the switching signal; and
controlling the main switch with the switching signal.

19. The method of claim 18, wherein sensing the voltage across the primary winding to generate the feedback signal that is indicative of the output voltage of the switching mode power supply comprises:
coupling an input resistor to the first terminal of the primary winding to sense a voltage at the first terminal of the primary winding;
coupling a feedback resistor to the second terminal of the primary winding to sense a voltage at the second terminal of the primary winding; and
subtracting the voltage from the second terminal of the primary winding from the voltage from the first terminal of the primary winding.

20. The method of claim 18, wherein generating the switching signal comprises:
generating a switching frequency control signal in response to the feedback signal;
generating a peak current control signal in response to the current sensed signal and the current reference signal; and
generating the switching signal in response to the switching frequency control signal and the peak current control signal.
